(19) United States
(12) Patent Application Publication
(10) Pub. No.: US 2008/0097038 A1
(43) Pub. Date: Apr. 24, 2008

(54) Moisture-Curable, Silane Crosslinking Compositions

(76) Inventors: Michael B. Biscoglio, Piscataway, NJ (US); John Klier, Midland, MI (US); Bharat I. Chaudhary, Princeton, NJ (US); Michael J. Mullins, Lake Jackson, TX (US); Christopher J. Tucker, Midland, MI (US)

Correspondence Address: Whyte Hirschboeck Dudek S.C., 555 East Wells Street, Suite 1900, Milwaukee, WI, 53202, US

(21) Appl. No.: 11/572,773

(22) PCT Filed: Aug. 1, 2005
(86) PCT No.: PCT/US05/27008

§ 371 Date: Jun. 7, 2007

Related U.S. Application Data
(60) Provisional application No. 60/599,000, filed on Aug. 5, 2004.

(51) Int. Cl. C08F 130/08

(52) U.S. Cl. 525/353

(57) ABSTRACT

Silane crosslinkable polymer compositions comprise (i) at least one silane crosslinkable polymer, e.g., ethylene-silane copolymer, and (ii) a catalytic amount of at least one polysubstituted aromatic sulfonic acid (PASA). The PASA catalysts are of the formula: HSO₃Ar—R₁(Rₓ)ₘ Where: m is 0 to 3; R₁ is (CH₂)ₙCH₃, and n is 0 to 3 or greater than 20; Each Rₓ is the same or different than R₁; and Ar is an aromatic moiety.

This invention relates to silane crosslinking compositions. In one aspect, the invention relates to moisture-curable, silane crosslinking compositions while in another aspect, the invention relates to such compositions comprising a sulfonic acid catalyst. In yet another aspect, the invention relates to silane crosslinked articles that were moisture-cured through the action of a sulfonic acid catalyst.

Silane-crosslinkable polymers, and compositions comprising these polymers, are well known in the art, e.g., U.S. Pat. No. 6,005,055, WO 02/12354 and WO 02/12355. The polymer is typically a polyolefin, e.g., polyethylene, into which one or more unsaturated silane compounds, e.g., vinyl trimethoxysilane, vinyl triethoxysilane, vinyl dimethoxyethoxysilane, etc., have been incorporated. The polymer is crosslinked upon exposure to moisture typically in the presence of a catalyst. These polymers have a myriad of uses, particularly in the preparation of insulation coatings in the wire and cable industry.

Important in the use of silane-crosslinkable polymers is their rate of cure. Generally, the faster the cure rate, the more efficient is their use. Polymer cure or crosslinking rate is a function of many variables not the least of which is the catalyst. Many catalysts are known for use in crosslinking polyolefins which bear unsaturated silane functionality, and among these are metal salts of carboxylic acids, organic bases, and inorganic and organic acids. Exemplary of the metal carboxylates is di-n-butyldilauryl tin (DBTDL), of the organic bases is pyridine, of the inorganic acids is sulfuric acid, and of the organic acids are the toluene and naphthalene disulfonic acids. While all of these catalysts are effective to one degree or another, new catalysts are of continuing interest to the industry, particularly to the extent that they are faster, or less water soluble, or more thermally stable (particularly to desulfonation), or more compatible with antioxidants, or less corrosive, or less prone to premature crosslinking (i.e., scorch), or cause less discoloration to the crosslinked polymer, or offer an improvement in any one of a number of different ways over the catalysts currently available for this purpose.

According to this invention, silane crosslinkable polymer compositions comprise (i) at least one silane crosslinkable polymer, and (ii) a catalytic amount of at least one polysubstituted aromatic sulfonic acid (PASA). These PASA catalysts are of the formula:

HSO₃Ar—R₁(Rₓ)ₘ

Where in a first instance:
m is 1 to 3;
R₁ is (CH₂)ₙCH₃, and n is 0 to 3;
Each Rₓ is the same or different than R₁; and
Ar is an aromatic moiety; and
   Where in a second instance:
m is 0 to 3;
R₁ is (CH₂)ₙCH₃, and n is greater than 20;
Each Rₓ is the same or different than R₁; and
Ar is an aromatic moiety.
   The catalysts of the second instance demonstrate lower water solubility than the catalysts of the first instance (the longer the length of the R₁ alkyl chain and the more alkyl chains on the aromatic moiety, the more compatible the catalyst is with the organic media of the polymer). The catalysts of the first instance, however, are readily prepared as sulfonated derivatives of alkylated toluene, ethyl benzene and xylene materials.

The silane crosslinkable polymer compositions of this invention comprise (i) at least one silane crosslinkable polymer, and (ii) a catalytic amount of at least one PASA. The silane crosslinkable polymers include silane-functionalized olefinic polymers such as silane-functionalized polyethylene, polypropylene, etc., and various blends of these polymers. Preferred silane-functionalized olefinic polymers include (i) the copolymers of ethylene and a hydrolysable silane, (ii) a copolymer of ethylene, one or more C₃ or higher α-olefins or unsaturated esters, and a hydrolysable silane, (iii) a homopolymer of ethylene having a hydrolysable silane grafted to its backbone, and (iv) a copolymer of ethylene and one or more C₃ or higher α-olefins or unsaturated esters, the copolymer having a hydrolysable silane grafted to its backbone.

Polyethylene polymer as here used is a homopolymer of ethylene or a copolymer of ethylene and a minor amount of one or more α-olefins of 3 to 20 carbon atoms, preferably of 4 to 12 carbon atoms, and, optionally, a diene or a mixture or blend of such homopolymers and copolymers. The mixture can be either an in situ blend or a post-reactor (or mechanical) blend. Exemplary α-olefins include propylene, 1-butene, 1-hexene, 4-methyl-1-pentene and 1-octene. Examples of a polyethylene comprising ethylene and an unsaturated ester are copolymers of ethylene and vinyl acetate or an acrylic or methacrylic ester.

The polyethylene can be homogeneous or heterogeneous. Homogeneous polyethylenes typically have a polydispersity (Mw/Mn) of about 1.5 to about 3.5, an essentially uniform comonomer distribution, and a single, relatively low melting point as measured by differential scanning calorimetry (DSC). The heterogeneous polyethylenes typically have a polydispersity greater than 3.5 and lack a uniform comonomer distribution. Mw is weight average molecular weight, and Mn is number average molecular weight.

The polyethylenes have a density in the range of about 0.850 to about 0.970 g/cc, preferably in the range of about 0.870 to about 0.930 g/cc. They also have a melt index (I₂) in the range of about 0.01 to about 2000, preferably about 0.05 to about 1000 and more preferably about 0.10 to about 50, g/10 min. If the polyethylene is a homopolymer, then its I₂ is preferably about 0.75 to about 3 g/10 min. The I₂ is determined under ASTM D-1238, Condition E and measured at 190 C and 2.16 kg.

The polyethylenes used in the practice of this invention can be prepared by any process including high-pressure, solution, slurry and gas phase using conventional conditions and techniques. Catalyst systems include Ziegler-Natta, Phillips, and the various single-site catalysts, e.g., metallocene, constrained geometry, etc. The catalysts are used with and without supports.

Useful polyethylenes include low density homopolymers of ethylene made by high pressure processes (HP-LDPEs), linear low density polyethylenes (LLDPEs), very low density polyethylenes (VLDPEs), ultra low density polyethylenes (ULDPEs), medium density polyethylenes (MDPEs), high density polyethylene (HDPE), and metallocene and constrained geometry copolymers.

High-pressure processes are typically free radical initiated polymerizations and conducted in a tubular reactor or a stirred autoclave. In the tubular reactor, the pressure is within the range of about 25,000 to about 45,000 psi and the temperature is in the range of about 200 to about 350 C. In the stirred autoclave, the pressure is in the range of about 10,000 to about 30,000 psi and the temperature is in the range of about 175 to about 250 C.

Copolymers comprised of ethylene and unsaturated esters are well known and can be prepared by conventional high-pressure techniques. The unsaturated esters can be alkyl acrylates, alkyl methacrylates, or vinyl carboxylates. The alkyl groups typically have 1 to 8 carbon atoms, preferably 1 to 4 carbon atoms. The carboxylate groups typically have 2 to 8 carbon atoms, preferably 2 to 5 carbon atoms. The portion of the copolymer attributed to the ester comonomer can be in the range of about 5 to about 50 percent by weight based on the weight of the copolymer, preferably in the range of about 15 to about 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate.

Examples of the vinyl carboxylates are vinyl acetate, vinyl propionate, and vinyl butanoate. The melt index of the ethylene/unsaturated ester copolymers is typically in the range of about 0.5 to about 50 g/10 min, preferably in the range of about 2 to about 25 g/10 min.

Copolymers of ethylene and vinyl silanes may also be used. Examples of suitable silanes are vinyltrimethoxysilane and vinyltriethoxysilane. Such polymers are typically made using a high-pressure process. Ethylene vinylsilane copolymers are particularly well suited for moisture-initiated crosslinking.

The VLDPE or ULDPE is typically a copolymer of ethylene and one or more α-olefins having 3 to 12 carbon atoms, preferably 3 to 8 carbon atoms. The density of the VLDPE or ULDPE is typically in the range of about 0.870 to about 0.915 g/cc. The melt index of the VLDPE or ULDPE is typically in the range of about 0.1 to about 20 g/10 min, preferably in the range of about 0.3 to about 5 g/10 min. The portion of the VLDPE or ULDPE attributed to the comonomer(s), other than ethylene, can be in the range of about 1 to about 49 percent by weight based on the weight of the copolymer, preferably in the range of about 15 to about 40 percent by weight.

A third comonomer can be included, e.g., another α-olefin or a diene such as ethylidene norbornene, butadiene, 1,4-hexadiene or a dicyclopentadiene. Ethylene/propylene copolymers are generally referred to as EPRs, and ethylene/propylene/diene terpolymers are generally referred to as an EPDM. The third comonomer is typically present in an amount of about 1 to about 15 percent by weight based on the weight of the copolymer, preferably present in an amount of about 1 to about 10 percent by weight. Preferably the copolymer contains two or three comonomers inclusive of ethylene.

The LLDPE can include VLDPE, ULDPE, and MDPE, which are also linear, but, generally, have a density in the range of about 0.916 to about 0.925 g/cc. The LLDPE can be a copolymer of ethylene and one or more α-olefins having 3 to 12 carbon atoms, preferably 3 to 8 carbon atoms. The melt index is typically in the range of about 1 to about 20 g/10 min, preferably in the range of about 3 to about 8 g/10 min.

Any polypropylene may be used in these compositions. Examples include homopolymers of propylene, copolymers of propylene and other olefins, and terpolymers of propylene, ethylene, and dienes (e.g. norbornadiene and decadiene). Additionally, the polypropylenes may be dispersed or blended with other polymers such as EPR or EPDM. Suitable polypropylenes include thermoplastic elastomers (TPEs), thermoplastic olefins (TPOs) and thermoplastic vulcanates (TPVs). Examples of polypropylenes are described in Polypropylene Handbook: Polymerization, Characterization, Properties, Processing, Applications 3-14, 113-176 (E. Moore, Jr. ed., 1996).

Vinyl alkoxysilanes (e.g., vinyltrimethoxysilane and vinyltriethoxysilane) are suitable silane compounds for grafting or copolymerization to form the silane-functionalized olefinic polymer.

The catalysts of the compositions of this invention are polysubstituted aromatic sulfonic acid (PASA) catalysts. These PASA catalysts are of the formula:

HSO₃Ar—R₁(Rₓ)ₘ

Where in a first instance:
m is 1 to 3;
R₁ is (CH₂)ₙCH₃, and n is 0 to 3;
Each Rₓ is the same or different than R₁; and
Ar is an aromatic moiety; and
   Where in a second instance:
m is 0 to 3;
R₁ is (CH₂)ₙCH₃, and n is greater than 20;
Each Rₓ is the same or different than R₁; and
Ar is an aromatic moiety.
   The aromatic moiety can be heterocyclic, e.g., a pyridine or quinoline, but preferably is benzene or naphthalene. The catalysts of the second instance include α-olefin sulfonates, alkane sulfonates, isethionates (ethers or esters of 2-hydroxyethylsulfonic acid also known as isethionic acid), and propane sulfone derivatives, e.g., oligomers or copolymers of acrylamido propane sulfonic acid. While the maximum value of n is limited only by practical considerations such as economics, catalyst mobility and the like, preferably the maximum value of n is about 80, more preferably about 50. The PASA typically comprises from about 0.01 to about 1, preferably from about 0.03 to about 0.5 and more preferably from about 0.05 to about 0.2, weight percent of the composition based upon the total weight of the composition.

The compositions of this invention may contain other components such as anti-oxidants, colorants, corrosion inhibitors, lubricants, anti-blocking agents, flame retardants, and processing aids. Suitable antioxidants include (a) phenolic antioxidants, (b) thio-based antioxidants, (c) phosphate-based antioxidants, and (d) hydrazine-based metal deactivators. Suitable phenolic antioxidants include methyl-substituted phenols. Other phenols, having substituents with primary or secondary carbonyls, are suitable antioxidants. One preferred phenolic antioxidant is isobutylidenebis(4,6-dimethylphenol). One preferred hydrazine-based metal deactivator is oxalyl bis(benzylidiene hydrazide). These other components or additives are used in manners and amounts known in the art. For example, the antioxidant is typically present in amount between about 0.05 and about 10 weight percent based on the total weight of the polymeric composition.

In one embodiment, the invention is a fabricated article such as a wire or cable construction prepared by applying the polymeric composition over a wire or cable. Other constructions include fiber, film, foam, ribbons, tapes, adhesives, footwear, apparel, packaging, automotive parts, refrigerator linings and the like. The composition may be formed, applied and used in any manner known in the art.

In another embodiment, the invention is a process of curing a composition comprising a silane-crosslinkable polymer using a PASA. The cure can be effected in any one of a number of known processes and a variety of conditions.

### EXAMPLES

### The following non-limiting examples illustrate the invention.

Two tests were used to demonstrate the effectiveness of the PASA catalysts in promoting the crosslinking of moisture-curable systems. The first test utilizes a Brookfield viscometer to measure rate and degree of silane crosslinking. It screens a variety of catalysts under well controlled conditions, and it is designed to simulate the cure of moisture-curable formulations for wires, cables, fibers, foams and adhesives. Examples 1-2 and Comparative Examples 1-4 use this Brookfield viscometer-based screening method.

The second test used lab plaques of the same materials and under similar processing conditions to those currently employed in wire and cable insulation products. The plaque method is also utilized to demonstrate the effectiveness of the disclosed catalysts in a preferred embodiment of this invention, i.e., as silane-crosslinking catalysts in wire and cable insulation products that provide cure rates that are appreciable faster at ambient conditions than existing catalysts, namely di-butyl tin dilaurate (DBTDL). Examples 3-4 and Comparative Examples 5-6 are based on this plaque screening method.

### Examples 1 to 2 and Comparative Examples 1 to 4

In the case of Comparative Examples 1-3 and Examples 1-2, varying amounts of catalysts were added to dry n-octane to make 1000 mg (1.422 ml) of solution, and the contents were stirred with a spatula. The amounts of catalyst used to make the “catalyst solution” are reported in Table 1 below (the residual amount is octane).

TABLE 1
Catalyst Solution

| | | Moisture Content | Catalyst Amount |
|---|---|---|---|
| Example | Catalyst | (ppm) | (mg) |
| C-1 | DBTDL¹ | NA² | 400 |
| C-2 | B201 Sulfonic Acid³ | 13,649 | 10.8 |
| C-3 | 4-Dodecylbenzene | 7764 | 11.1 |
| | Sulfonic Acid | | |
| 1 | Aristonate F⁴ | 14,369 | 10.1 |
| 2 | Witconate AS304⁵ | 7,651 | 10.4 |

¹Di-n-butyldilauryl tin
²Not Available
³Available from King Industries (#17097)
⁴C₂₀₋₂₄ alkyl toluene sulfonic acid
⁵C₂₀₋₂₄ alkyl benzene sulfonic acid

A water-saturated sample of n-octane was prepared by mixing the n-octane with 1 volume percent (vol %) water, and stirring for 1 hour at room temperature (22° C.). The two-phase mixture was allowed to settle for at least 1 hour, and the upper layer was then decanted carefully to collect the water-saturated octane (the “wet octane”). The solubility of water in octane at 22° C., as determined by Karl-Fischer titration, is 50 ppm. The wet octane (4.5 grams) was used to dissolve 500 mg of poly(ethylene-co-octene) grafted with 1.6 weight percent (wt %) vinyltriethoxysilane (POE-g-VTES) at about 40° C. to obtain a clear and colorless solution comprising 1:9 w:w (weight ratio) polymer:octane. In the case of Comparative Examples 1-3 and Examples 1-2, a fixed amount (0.200 mL) of the catalyst solution described above was added and mixed with the 5.0 grams of POE-g-VTES/octane solution using a syringe.

Comparative Example 4 was prepared differently by directly adding 50 mg of 2-acrylamido-2-methyl-1-propane sulfonic acid (which is a solid at room temperature) to the 5.0 gram of POE-g-VTES/octane solution (instead of first dissolving in n-octane), and then mixing with an ultrasonic cleaner at 40° C. for 5 minutes. A 1.5 ml portion of the final solution was loaded into a preheated (40° C.) Brookfield-HADVII cone and plate viscometer, and a CP 40 spindle was lowered onto the sample. The motor was started and the speed of rotation of the spindle was maintained at 2.5 rpm. The torque reading in mV was monitored over time. The increase in torque over time is a measure of the rate of crosslinking. The effective catalyst concentrations are reported in Table 2 below.

TABLE 2
Effective Catalyst Concentration in 5.0 g
of POE-g-VTES/Octane Solution

| Example | Catalyst Concentration (mg) |
|---|---|
| C-1 | 56.26* |
| C-2 | 1.52 |
| C-3 | 1.56 |
| C-4 | 50 |
| 1 | 1.42 |
| 2 | 1.46 |

*(400 × 0.2)/1.422 = 56.26 mg

The results from the Brookfield viscometer are presented in Table 3 below.

TABLE 3
Brookfield Viscometer Results

| | Initial | | |
|---|---|---|---|
| | Viscosity at | Time for 2 mV | Time for 6 mV |
| | 0 min | Increase from 0 min | Increase from 0 min |
| Example | (mV) | (min) | (min) |
| C-1 | 12 | 160 | 282 |
| C-2 | 14 | 9.1 | 9.6 |
| C-3 | 13 | 7.6 | 9.8 |
| C-4 | 12.5 | 185 | NA* |
| 1 | 13 | 7.4 | 8.6 |
| 2 | 13 | 6.3 | 8.6 |

*Not Available

Assuming a linear effect of catalyst concentration on cross-linking kinetics, Table 4 reports the corresponding times per mg of catalyst.

TABLE 4
Cure Times as a Function of Catalyst Concentration

| | Time for 2 mV | Time for 6 mV |
|---|---|---|
| | Increase | Increase |
| Example | (min) | (min) |
| C-1 | 9,002 | 15,865 |
| C-2 | 14 | 15 |
| C-3 | 12 | 15 |
| C-4 | 9,250 | NA* |
| 1 | 11 | 12 |
| 2 | 9 | 13 |

*Not Available

The sulfonic acids of Examples 1 and 2 yielded not only a desirably fast cross-linking, but the rate of cross-linking was better than that of the sulfonic acids of Comparative Examples 2 and 3. In contrast, the insoluble sulfonic acid compositions in Comparative Example 4 was not very effective at accelerating crosslinking.

### Examples 3-4 and Comparative Examples 5-6

These examples and comparative examples were based on the plaque method which utilizes the same materials that are used for the fabrication of a wire and cable product. However, instead of extruding the insulation onto wire and monitoring cure, the polymer composition is prepared as plaques. The polymer composition was prepared in a 250 g mixing bowl that was purged with nitrogen. The ethylene/silane-base resin (DFDA-5451) was added to the bowl and fluxed at 150° C. and then the antioxidant (Lowinox 22IB46) and catalyst wee added to the melt. The polymer composition was mixed for 5 minutes, and then it is immediately transferred into a 30 mil mold at 150° C. Dogbone plaques were then cut out of these forms, cured under ambient conditions (23° C., 70% relative humidity), and evaluated for cure using Hot Set by methods well known in the art, e.g., CEI/IEC 60502-1, Ed. 1.1 (1998), International Electrotechnical Commission, Geneva, Switzerland.

Table 5 lists the percent by weight of each component that was used in preparing Examples 3-4 and Comparative Examples 5-6. The ethylene-silane copolymer (DFDA-5451) is a reactor copolymer prepared with 1.5% vinyltrimethoxysilane (VTMS), and it constituted the polymer embodiment of each system. As can be seen in Table 5, all of the compositions used the same level of copolymer, antioxidant (Lowinox 221B46 which is isobutylidene(4,6-dimethylphenol) supplied by Great Lakes Chemical) and catalyst by weight, so that each could be evaluated under a weight equivalence factor. Comparative Example 5 was prepared with DBTDL so that its performance could be compared directly with the catalysts of the invention. Comparative Example 6 was prepared with Nacure B201, a sulfonic acid catalyst supplied by King Industries, and it was expected to perform faster than DBTDL. The Aristonate F and Witconate AS304 are Examples 3 and 4 of the invention, and they represent the first and second instances, respectively, of the catalysts used in the practice of the instant invention.

TABLE 5
Polymer Composition in Percent by Weight

| | DFDA- | Lowinox | | NACURE | WITCONATE | |
|---|---|---|---|---|---|---|
| Example | 5451 | 221B46 | DBTDL | B201 | AS304 | ARISTONATE F |
| C-5 | 99.65 | 0.20 | 0.15 | | | |
| C-6 | 99.65 | 0.20 | | 0.15 | | |
| 3 | 99.65 | 0.20 | | | 0.15 | |
| 4 | 99.65 | 0.20 | | | | 0.15 |

Table 6 reports the Hot Set or creep measured following curing of each of these polymer compositions under ambient conditions. All the samples were tested prior to conditioning (0 days) in order to verify that none had crosslinked. A sample was considered a failure if it either broke during the test or achieved a Hot Set value of greater than 175%. As shown in Table 6, the compositions prepared with Witconate AS304 and Aristonate F passed Hot Set within 16 hours, while the Nacure B201 passed within 1 day. The DBTDL-cure took a week to pass the test. The substantially faster cure rate of the polymer compositions comprising Witconate AS304 or Aristonate F not only validated that Witconate AS304 and Aristonate F are suitable catalysts for the crosslinking of moisture curable systems under ambient conditions, but their passing Hot Set in less time than that required for compositions comprising Nacure B201 catalyst indicates they are preferable over other sulfonic acid catalysts.

TABLE 6
Hot Set Measured in Days Cured at 23 C. and 70% Relative Humidity

| Example | 0 | 0.75 | 1 | 2 | 3 | 7 |
|---|---|---|---|---|---|---|
| C-5 | Failed | Failed | Failed | Failed | Failed | 28.28 |
| C-6 | Failed | Failed | 19.42 | 19.42 | 28.61 | 32.55 |
| 3 | Failed | 18.11 | 22.05 | 46.98 | 39.11 | 25.98 |
| 4 | Failed | 18.11 | 57.48 | 35.17 | 31.23 | 23.36 |

Although the invention has been described in considerable detail through the preceding examples, this detail is for the purpose of illustration and is not to be construed as a limitation upon the invention as described in the following claims.

What is claimed is:

1. A silane-crosslinkable polymer composition comprising (i) at least one silane-crosslinkable polymer, and (ii) a catalytic amount of at least one polysubstituted aromatic sulfonic acid of the formula:
HSO₃Ar—R₁(Rₓ)ₘ
Where:
m is 0 to 3;
R₁ is (CH₂)ₙCH₃, and n is 0 to 3 or greater than 20;
Each Rₓ is the same or different than R₁; and
Ar is an aromatic moiety.

2. The composition of claim 1 in which n is 0 to 3.

3. The composition of claim 1 in which n is greater than 20.

4. The composition of claim 1 in which Ar is a moiety derived from benzene or naphthalene.

5. The composition of claim 1 in which each Rₓ is the same.

6. The composition of claim 1 in which each Rₓ is the different.

7. The composition of claim 1 in which the polysubstituted aromatic sulfonic acid is at least one of an α-olefin sulfonate, alkane sulfonate, isethionate and a propane sulfone derivative.

8. The composition of claim 1 in which the silane-crosslinkable polymer is a silane-functionalized olefinic polymer.

9. The composition of claim 1 in which the silane-crosslinkable polymer is a silane-functionalized polypropylene.

10. The composition of claim 1 in which the silane-functionalized olefinic polymer is at least one of a (i) copolymer of ethylene and a hydrolysable silane, (ii) copolymer of ethylene, one or more C₃ or higher α-olefins or unsaturated esters, and a hydrolysable silane, (iii) homopolymer of ethylene having a hydrolysable silane grafted to its backbone, and (iv) a copolymer of ethylene and one or more C₃ or higher α-olefins or unsaturated esters, the copolymer having a hydrolysable silane grafted to its backbone.

11. The composition of claim 1 in which the silane functionality of the silane-crosslinkable polymer is derived from a vinyl alkoxysilane.

12. The composition of claim 1 in which the polysubstituted aromatic sulfonic acid is present in an amount of about 0.01 to about 1 weight percent based upon the total weight of the composition.

13. The composition of claim 1 in which the polysubstituted aromatic sulfonic acid is present in an amount of about 0.03 to about 0.5 weight percent based upon the total weight of the composition.

14. The composition of claim 1 crosslinked as a result of exposure to moisture.

15. An article manufactured from the composition of claim 1.

16. The article of claim 15 in the form of a wire or cable insulation coating.

17. The article of claim 15 in the form of a fiber, film, foam, ribbon, tape, adhesive, footwear, apparel, packaging, automotive part or refrigerator lining.
